(19) United States
(12) Patent Application Publication
(10) Pub. No.: US 2020/0293974 A1
(43) Pub. Date: Sep. 17, 2020

(54) SKILLS-BASED MATCHING OF EDUCATION AND OCCUPATION

(71) Applicant: Microsoft Technology Licensing, LLC, Redmond, WA (US)

(72) Inventors: Akash Kaura, Singapore (SG); Pei Ying Chua, Singapore (SG)

(21) Appl. No.: 16/299,970

(22) Filed: Mar. 12, 2019

(51) Int. Cl. G06Q 10/06; G06Q 10/10

(52) U.S. Cl. CPC G06Q 10/063112; G06Q 10/1053

(57) ABSTRACT

The disclosed embodiments provide a system for processing data. During operation, the system aggregates a first set of skills associated with an occupation represented by one or more attributes. Next, the system aggregates a second set of skills associated with a course of study represented by one or more additional attributes. The system then calculates a match score representing a similarity between the first set of skills and the second set of skills. Finally, the system stores the match score in association with the occupation and the course of study.

### BACKGROUND

### Field

The disclosed embodiments relate to techniques for characterizing educational and occupational attributes. More specifically, the disclosed embodiments relate to techniques for performing skills-based matching of education and occupation.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online networks may facilitate other types of activities and operations. For example, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows the calculation of a match score between an occupation and a course of study in accordance with the disclosed embodiments.

FIG. 4 shows a flowchart illustrating the processing of data in accordance with the disclosed embodiments.

FIG. 5 shows a flowchart illustrating a process of calculating a match score between an occupation and a course of study in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing skills-based matching of education and occupation. In these embodiments, different types of education can be differentiated by degree, field of study, certificate, certification, and/or other attributes pertaining to different courses of study. Different occupations can be differentiated by attributes such as a standardized title, industry, and/or seniority associated with a set of jobs.

More specifically, the disclosed embodiments include functionality to perform pairwise comparison and/or matching of courses of study and occupations based on skills associated with the courses of study and occupations. A set of skills associated with each course of study may be aggregated based on one or more educational attributes associated with the course of study, and a set of skills associated with each occupation may be aggregated based on one or more occupational attributes associated with the occupation. For example, skills associated a given course of study are extracted from member profiles in an online system that contain a degree and/or field of study representing the course of study. Skills associated with a given occupation are extracted from jobs posted in the online system that specify a standardized title representing the occupation.

Aggregated skills for pairs of courses of study and occupations are then used to calculate match scores between the pairs. For example, scores for individual skills within each course of study and occupation may be calculated based on a term frequency-inverse document frequency (tf-idf) associated with each skill. Scores for skill sets related to a (course of study, occupation) pair are then be combined into an overall match score between the course of study and occupation. In turn, the match score represents a measure of similarity and/or overlap between the skill sets of the course of study and occupation.

Match scores between multiple pairs of courses of study and occupations may additionally be used to generate insights and/or recommendations related to the courses of study and occupations. For example, the match scores may be used to recommend educational pathways that provide the best preparation for a certain occupation. In another example, the match scores may be used to recommend occupations for which a certain degree and field of study provides the best preparation.

By using aggregated skills to characterize and compare occupations and courses of study, the disclosed embodiments generate high-granularity predictions and/or insights related to career planning, educational planning, and/or hiring outcomes. Such predictions and/or insights may additionally be incorporated into recommendations and/or search results in job search tools, recruiting tools, educational technology products, and/or career planning tools in the online system. In turn, job seekers, recruiters, schools, and/or other entities involved in developing and/or using skills can use the predictions and/or insights to improve skills-based job searches, job placement, and/or education. In contrast, conventional techniques may perform coarser matching and/or comparison of occupations and courses of study (e.g., comparing required degrees and fields of study for jobs with those attained by applicants), which may fail to reveal how well the courses of study are preparing students for jobs and/or responding to job market needs. Consequently, the system may improve computer systems, applications, user experiences, tools, and/or technologies related to user recommendations, machine learning, employment, career planning, educational technology, recruiting, and/or hiring.

### Skills-Based Matching of Education and Occupation

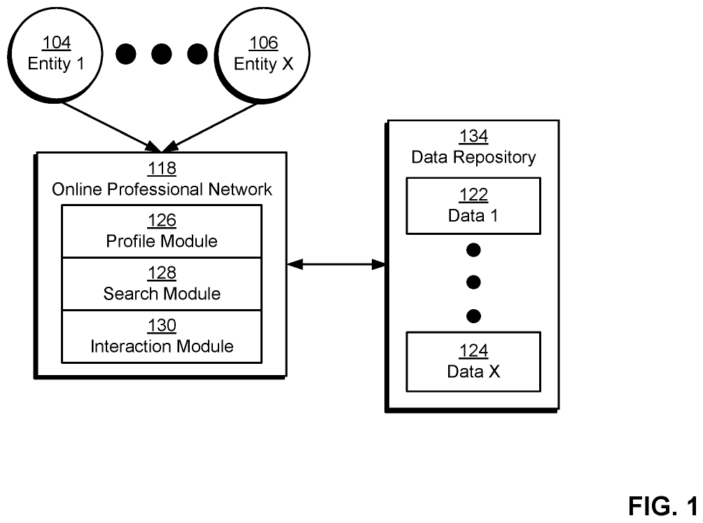

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

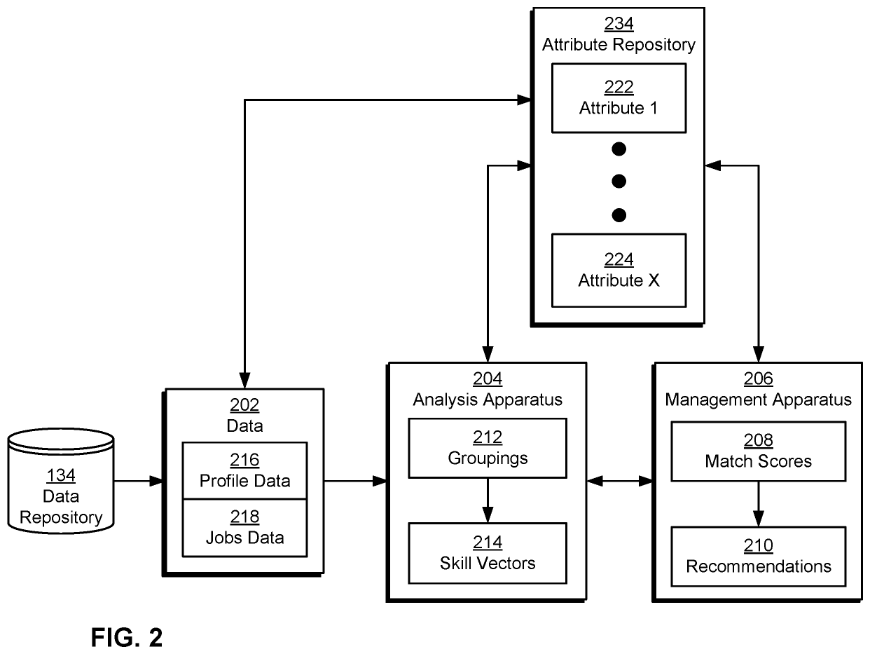

As shown in FIG. 2, data repository 134 and/or another primary data store may be queried for data 202 that includes profile data 216 for members of an online system (e.g., online network 118 of FIG. 1), as well as jobs data 218 for jobs that are listed and/or described within and/or outside the online system. Profile data 216 includes data associated with member profiles in the online system. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online system.

Attributes of the members from profile data 216 may be matched to a number of member segments, with each member segment containing a group of members that share one or more common attributes. For example, member segments in the online system may be defined to include members with the same industry, title, location, and/or language.

Connection information in profile data 216 may additionally be combined into a graph, with nodes in the graph representing entities (e.g., users, schools, companies, locations, etc.) in the online system. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted and/or provided by members of the online system and/or external entities. For example, jobs data 218 for a given job or job listing may include a declared or inferred title, company, required or desired skills, responsibilities, qualifications, role, location, industry, seniority, salary range, benefits, and/or member segment.

Attribute repository 234 stores data that represents standardized, organized, and/or classified attributes (e.g., attribute 1 222, attribute x 224) in profile data 216 and/or jobs data 218. For example, skills in profile data 216 and/or jobs data 218 may be organized into a hierarchical taxonomy that is stored in attribute repository 234 and/or another repository. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in attribute repository 234 may include cities, metropolitan areas, states, countries, continents, and/or other standardized geographical regions. In a third example, attribute repository 234 includes standardized company names for a set of known and/or verified companies associated with the members and/or jobs. In a fourth example, attribute repository 234 includes standardized titles, seniorities, and/or industries for various jobs, members, and/or companies in the social network. In a fifth example, attribute repository 234 includes standardized degrees, fields of study, certificates, certifications, and/or licenses. In a sixth example, attribute repository 234 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.).

In one or more embodiments, profile data 216 and jobs data 218 are used to characterize and/or compare skill sets across entities represented by different groupings 212 of standardized attributes in attribute repository 234. In some embodiments, such entities include fields of study and occupations.

An analysis apparatus 204 generates groupings 212 related to courses of study by one or more educational attributes, and generates groupings 212 related to occupations by one or more occupational attributes. For example, analysis apparatus 204 may define courses of study by unique values and/or groupings 212 of degrees (e.g., associate's degree, bachelor's degree, master's degree, doctorate of philosophy, medical degree, law degree, business degree, etc.) and/or fields of study (e.g., music, dance, art, theatre, film, communications, history, linguistics, literature, philosophy, theology, anthropology, archaeology, economics, law, mechanical engineering, electrical engineering, chemical engineering, mathematics, psychology, medicine, computer science, etc.) in attribute repository 234. In another example, analysis apparatus 204 may define courses of study by unique values and/or groupings 212 of certificates, certifications, and/or licenses. In a third example, analysis apparatus 204 may define occupations by unique values and/or groupings of standardized titles, industries, and/or seniorities in attribute repository 234.

Analysis apparatus 204 uses attributes in groupings 212 to aggregate skills associated with the corresponding courses of study and occupations. First, analysis apparatus 204 extracts skills associated with courses of study from member profiles in the online system that share the corresponding educational attributes. For example, analysis apparatus 204 may match a degree, field of study, certification, certificate, license, and/or other attributes associated with a given course of study to a set of member profiles that contain the attributes. Within each of the member profiles, analysis apparatus 204 may identify a time spanned by the course of study (e.g., a certain number of weeks, months, or years over which the course of study took place) and identify one or more skills added to the member profile within a “window” around the time (e.g., from the start of the course of study to one year after the end of the course of study). Analysis apparatus 204 may then aggregate all such skills from all member profiles with the attributes into a set of skills associated with the field of study and/or a count of each skill within the field of study.

Second, analysis apparatus 204 extracts skills associated with occupations from jobs in the online system that share the corresponding occupational attributes. For example, analysis apparatus 204 may match a standardized title for an occupation to a set of job postings and/or job descriptions containing the standardize title. Analysis apparatus 204 may then aggregate all skills mentioned and/or listed in the job postings and/or descriptions into a set of skills associated with the occupation and/or a count of each skill within the occupation.

Analysis apparatus 204 uses the aggregated skills to generate skill vectors 214 for the corresponding entities. Each skill vector may include a set of scores reflecting the “representativeness” (e.g., uniqueness, prevalence, importance, etc.) of a set of skills in a grouping of attributes for a course of study or occupation. A higher score may indicate a skill that is more representative of entities in the grouping, and a lower score may represent a skill that is less representative of entities in the grouping.

For example, each score may be calculated using a term frequency-inverse document frequency (tf-idf) calculated from counts of the corresponding skill within the grouping and across multiple groupings of the entities. As a result, the score may be higher when the skill appears frequently within the grouping and infrequently in other groupings. In other words, the score may be proportional to the prevalence or occurrence of the skill within the grouping and inversely proportional to the occurrence of the skill across groupings.

After a score for a given skill is calculated for a corresponding grouping, analysis apparatus 204 stores the skill in an entry or element representing the skill within a skill vector for the grouping. For example, analysis apparatus 204 may store scores for thousands or tens of thousands of standardized skills in the online system in a vector representing the grouping, with the length of the vector set to the number of standardized skills. Within the vector, each entry or element (e.g., dimension of the vector) represents a different standardized skill and stores a score representing the representativeness of the skill in the grouping.

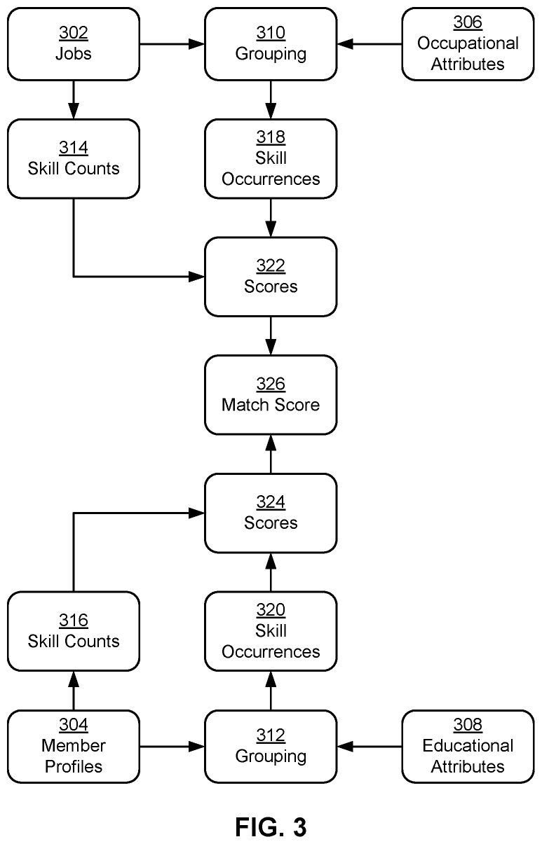

After skill vectors 214 are calculated for all relevant groupings 212 of entities, a management apparatus 206 uses skill vectors 214 to generate match scores 208 between pairs of groupings 212. For example, management apparatus 206 may generate match scores 208 as cosine similarities, Jaccard distances, and/or other measures of similarity or overlap between skill vectors 214 of various (course of study, occupation) pairs. As a result, match scores 208 may characterize and/or reflect the similarity and/or overlap in skills between the corresponding courses of study and occupations. Calculation of match scores between courses of study and occupations is described in further detail below with respect to FIG. 3.

Management apparatus 206 also generates and/or outputs recommendations 210 based on match scores 208. For example, management apparatus 206 may group match scores 208 by course of study; within each course of study, management apparatus 206 may order occupations by match scores 208 with the course of study. Management apparatus 206 may use the ordered occupations and/or corresponding match scores 208 to identify occupations that have high skill-based similarity or overlap with the course of study. Management apparatus 206 may then output the occupations as recommended occupations to pursue after the course of study. Management apparatus 206 may also, or instead, generate recommendations 210 of jobs associated with the occupations to candidates that list the course of study in their member profiles. Management apparatus 206 may also, or instead, generate recommendations 210 of candidates that list the course of study to posters of the jobs (e.g., recruiters, hiring managers, etc.).

In another example, management apparatus 206 may group match scores 208 by occupation; within each occupation, management apparatus 206 may order courses of study by match scores 208 with the occupation. Management apparatus 206 may use the ordered courses of study and/or corresponding match scores to identify individual courses of study and/or educational pathways (e.g., a series of degrees and fields of study) that have high skill-based similarity and/or overlap with the occupation. Management apparatus 206 may then output the courses of study and/or educational pathways as recommendations within an e-learning product and/or educational planning tool. Management apparatus 206 may also, or instead, suggest the courses of study and/or educational pathways to job seekers that have indicated interest in the occupation and lack one or more skills associated with the occupation that can be provided by the courses of study and/or educational pathways.

By using aggregated skills to characterize and compare occupations and fields of study, the system of FIG. 2 may generate predictions and/or insights related to career planning, educational planning, and/or hiring outcomes. Such predictions and/or insights may additionally be incorporated into recommendations and/or search results in job search tools, recruiting tools, educational technology products, and/or career planning tools. Consequently, the system may improve computer systems, applications, user experiences, tools, and/or technologies related to user recommendations, machine learning, employment, career planning, educational technology, recruiting, and/or hiring.

Those skilled in the art will appreciate that the system of FIG. 2 may be implemented in a variety of ways. First, analysis apparatus 204, management apparatus 206, data repository 134, and/or attribute repository 234 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, the generation of groupings 212 and/or skill vectors 214 may be tuned to characterize and/or compare the skill sets of the entities at different granularities. For example, groupings 212 of entities may be generated from different numbers of attributes to assess the skill sets of the entities at multiple levels of specificity. Thus, a general distribution of skills in members, jobs, and/or other entities may be determined by calculating skill vectors 214 for groupings 212 of the entities by a smaller number of attributes (e.g., jobs with the same standardized title, members with the same degree, members with the same field of study, etc.). Conversely, more specific skill-based assessments of the entities may be performed by generating skill vectors 214 from groupings 212 of the entities by a larger number of attributes (e.g., jobs with the same standardized title, seniority, and industry; members with the same degree and field of study and/or combination of degrees and fields of study; etc.). In another example, scores for individual skills in skill vectors 214 may be aggregated into scores for groups of related skills (e.g., technical skills, industry-based skills, skills associated with a particular field of study, etc.) to characterize and/or compare groupings 212 of entities by the skill groups, in lieu of or in addition to characterization and/or comparison of groupings 212 by the individual skills.

Those skilled in the art will also appreciate that the functionality of the system may be adapted to characterize and/or compare other types of data. For example, vectors of scores may be used to characterize and/or compare connection strengths, educational characteristics, employment histories, interests, preferences, volunteer activities, groups, follows, and/or other types of profile data 216 and/or jobs data 218 for various occupations and courses of study.

FIG. 3 shows the calculation of a match score 326 between an occupation and a course of study in accordance with the disclosed embodiments. As described above, the occupation may be represented by a grouping 310 of one or more occupational attributes 306, and the course of study may be represented by another grouping 312 of one or more educational attributes 308. For example, the occupation may be associated with a standardized title, industry, and/or seniority, and the course of study may be associated with a standardized degree, field of study, certification, and/or certificate.

Next, a set of scores 322 is calculated for grouping 310 based on skill counts 314 and skill occurrences 318 within a set of jobs 302, and another set of scores 324 is calculated for grouping 312 based on skill counts 316 and skill occurrences 320 within a set of member profiles 304. Skill counts 314-316 may include counts of each skill within the corresponding groupings 310-312. For example, a group of jobs 302 with the same standardized title may have skill counts 314 representing the number of times each skill appears in the group. In another example, a group of member profiles 304 that list the same degree and/or field of study may have skill counts 314 representing the number of times each skill appears in the group within a window around a duration of the course of study involving the degree and/or field of study. In other words, a skill count for a skill may represent the term frequency (tf) of the skill within a given grouping 310-312 of jobs 302 or member profiles 304.

Skill occurrences 318-320 may represent occurrences of the skills across multiple groupings of occupational attributes 306 and educational attributes 308. For example, skill occurrences 318 may be calculated as the inverse document frequency (idf) of each skill across groupings of jobs 302 by standardized title. In another example, skill occurrences 320 may be calculated as the idf of each skill across groupings of member profiles 304 by degree and/or field of study, after member profiles 304 have been filtered to remove skills that lie outside the windows around degrees and/or fields of study.

The idf may be calculated by applying a logarithm to the total number of groupings by a given set of occupational attributes 306 or educational attributes 308 divided by the number of groupings in which the skill is found:

IDF(s, A)=log(|A|/(1+nₛ))

In the above equation, “A” represents multiple groupings by a set of attributes, and “nₛ” represents the number of groupings in which skill “s” is found. Because certain skills can be found at least once in almost all groupings (e.g., a skill of “C++” in groupings of jobs 302 by title), the skill may be deemed to be part of a grouping only when the occurrence of the skill in the grouping exceeds a threshold (e.g., if the skill is included in the top 100 skills for the grouping).

Scores 322 may be calculated by multiplying skill counts 314 by skill occurrences 318 for the corresponding skills. Similarly, scores 324 may be calculated by multiplying skill counts 316 by skill occurrences 320 for the corresponding skills. In other words, each score may be calculated as a tf-idf of the corresponding skill for a grouping of jobs 302 or member profiles 304 by corresponding occupational attributes 306 or educational attributes 308.

Scores 322 from an occupation represented by a given grouping 310 of jobs 320 by one or more occupational attributes 306 may then be combined with scores 324 from a course of study represented by a given grouping 312 of member profiles 304 by one or more educational attributes 308 to produce a match score 326 between the occupation and course of study. For example, match score 326 may be calculated using the following formula:

$${J}_{{D}_{1}}^{{O}_{1}} = 1 - \frac{{\sum }_{1}^{n} {s}_{i}}{{\sum }_{1}^{N} {S}_{j}}$$

In the above formula, J represents match score 326, O₁ represents an occupation, and D₁ represents a course of study. Match score 326 may be produced by dividing the summation of scores 322 for skills in the occupation sᵢ by the summation of scores of scores 324 for skills in the course of study Sⱼ and subtracting the result from 1. In addition, n≤N (i.e., the number of skills in the occupation is less than the number of skills in the course of study) and sᵢₜ≤Sₜ for a given skill t (i.e., the score for the skill in the occupation is lower than the score for the skill in the course of study).

Consequently, match score 326 may be calculated as a “modified” Jaccard distance between scores 322 of the occupation and scores 324 of the course of study. For example, if the occupation includes skills of “SQL” and “Java” and the course of study includes skills of “SQL,” “Java” and “Python,” match scores 326 may be calculated as 1−(s_{SQL}+s_{Python})/(S_{SQL}+S_{Python}+S_{Java}).

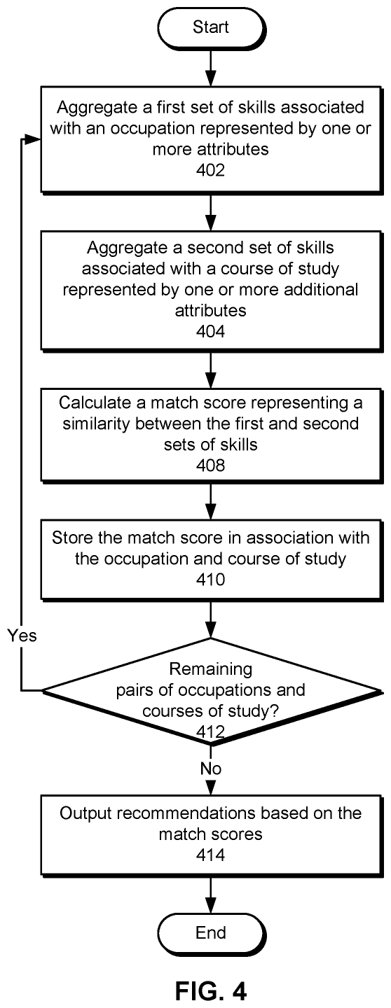

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a first set of skills associated with an occupation represented by one or more attributes is aggregated (operation 402), and a second set of skills associated with a course of study represented by one or more additional attributes is aggregated (operation 404). For example, the first set of skills may be aggregated from jobs that share a standardized title, industry, and/or seniority. In another example, the second set of skills may be aggregated from member profiles that share a degree, field of study, certification, and/or certificate. The second set of skills may be produced by determining one or more skills added to a member profile within a window around a duration of the course of study and including the skill(s) in the second set of skills.

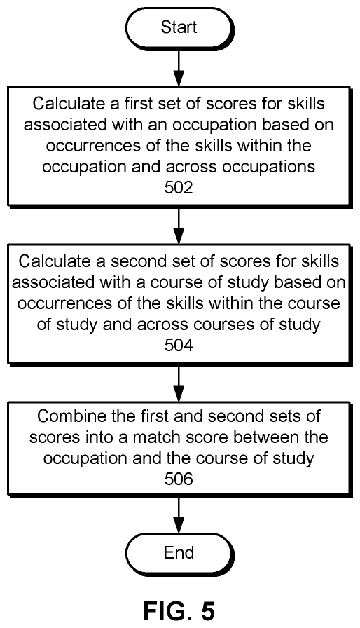

Next, a match score representing a similarity between the first and second sets of skills is calculated (operation 408), as described in further detail below with respect to FIG. 5. The match score is then stored in association with the occupation and course of study (operation 410). For example, the match score may be stored in a record containing attribute values associated with the occupation and course of study and/or identifiers for the occupation and course of study.

Operations 402-410 may be repeated for remaining pairs of occupations and courses of study (operation 412). For example, match scores may be calculated for every combination of occupation and course of study and/or a subset of combinations of occupation and course of study.

Recommendations are then outputted based on the match scores (operation 414). For example, recommended courses of study and/or educational pathways may be outputted for a given occupation. In another example, recommended occupations may be outputted for a given course of study and/or educational pathway.

FIG. 5 shows a flowchart illustrating a process of calculating a match score between an occupation and a course of study in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

Initially, a first set of scores for skills associated with an occupation is calculated based on occurrences of the skills within the occupation and across occupations (operation 502). Similarly, a second set of scores for skills associated with a course of study is calculated based on occurrences of the skills within the course of study and across courses of study (operation 504). For example, each score may be calculated as the tf-idf of the corresponding skill for a corresponding occupation or field of study.

The first and second sets of scores are then combined into a match score between the occupation and the course of study (operation 506). For example, the match score may be calculated as a cosine similarity, Jaccard distance, overlap coefficient, and/or other measure of similarity or overlap between sets.

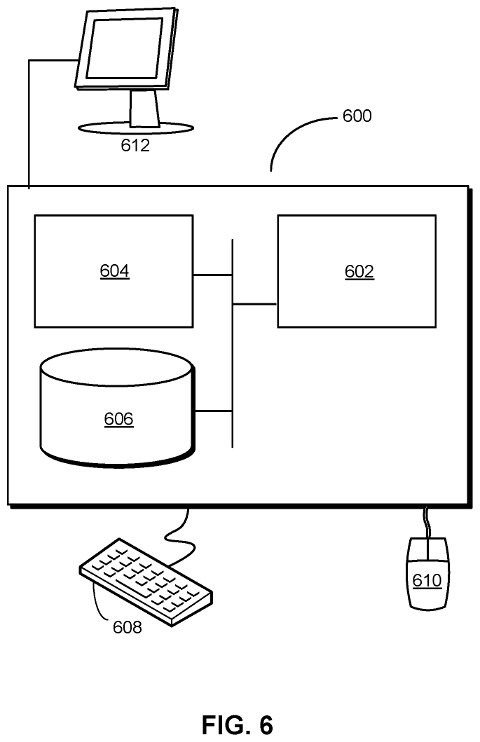

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system includes an analysis apparatus and a management apparatus, one or more of which may alternatively be termed or implemented as a module, mechanism, or other type of system component. The analysis apparatus aggregates a first set of skills associated with an occupation represented by one or more attributes. The analysis apparatus also aggregates a second set of skills associated with a course of study represented by one or more additional attributes. The management apparatus then calculates a match score representing a similarity between the first set of skills and the second set of skills. Finally, the management apparatus stores the match score in association with the occupation and the course of study.

In addition, one or more components of computer system 600 may be remotely located and connected to the other components over a network. Portions of the present embodiments (e.g., analysis apparatus, management apparatus, data repository, attribute repository, online professional network, etc.) may also be located on different nodes of a distributed system that implements the embodiments. For example, the present embodiments may be implemented using a cloud computing system that characterizes and/or compares the skill sets of occupations and courses of study for a set of remote entities.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
aggregating, by one or more computer systems, a first set of skills associated with an occupation represented by one or more attributes;
aggregating, by the one or more computer systems, a second set of skills associated with a course of study represented by one or more additional attributes;
calculating, by the one or more computer systems, a match score representing a similarity between the first set of skills and the second set of skills; and
storing the match score in association with the occupation and the course of study.

2. The method of claim 1, further comprising:
outputting a recommendation based on the match score and additional match scores between occupations and courses of study.

3. The method of claim 2, wherein the recommendation comprises at least one of:
a recommended course of study for the occupation;
a recommended educational pathway for the occupation; and
a recommended occupation for the course of study.

4. The method of claim 1, wherein aggregating the first set of skills associated with the occupation comprises:
aggregating the first set of skills from jobs that share the one or more attributes.

5. The method of claim 1, wherein aggregating the second set of skills associated with the course of study comprises:
aggregating the second set of skills from member profiles that share the one or more additional attributes.

6. The method of claim 5, wherein aggregating the second set of skills from the member profiles that share the one or more additional attributes comprises:
determining one or more skills added to a member profile within a window around a duration of the course of study; and
including the one or more skills in the second set of skills.

7. The method of claim 1, wherein calculating the match score representing the similarity between the first set of skills and the second set of skills comprises:
calculating a first set of scores for the first set of skills based on occurrences of the first set of skills within the occupation;
calculating a second set of scores for the second set of skills based on occurrences of the second set of skills within the course of study; and
combining the first and second sets of scores into the match score.

8. The method of claim 7, wherein calculating the match score the similarity between the first set of skills and the second set of skills further comprises:
adjusting the first set of scores based on occurrences of the first set of skills across occupations; and
adjusting the second set of scores based on occurrences of the second set of skills across courses of study.

9. The method of claim 1, wherein the match score comprises a Jaccard distance.

10. The method of claim 1, wherein the one or more attributes comprise at least one of:
a standardized title;
a seniority; and
an industry.

11. The method of claim 1, wherein the one or more additional attributes comprise at least one of:
a degree;
a field of study;
a certification; and
a certificate.

12. A system, comprising:
one or more processors; and
memory storing instructions that, when executed by the one or more processors, cause the system to:
aggregate a first set of skills associated with an occupation represented by one or more attributes;
aggregate a second set of skills associated with a course of study represented by one or more additional attributes;
calculate a match score representing a similarity between the first set of skills and the second set of skills; and
store the match score in association with the occupation and the course of study.

13. The system of claim 12, wherein the memory further stores instructions that, when executed by the one or more processors, cause the system to:
output a recommendation based on the match score and additional match scores between occupations and courses of study.

14. The system of claim 12, wherein aggregating the first set of skills associated with the occupation comprises:
aggregating the first set of skills from jobs that share the one or more attributes.

15. The system of claim 12, wherein aggregating the second set of skills from the member profiles that share the one or more additional attributes comprises:
determining one or more skills added to a member profile within a window around a duration of the course of study; and
including the one or more skills in the second set of skills.

16. The system of claim 12, wherein calculating the match score representing the similarity between the first set of skills and the second set of skills comprises:
calculating a first set of scores for the first set of skills based on occurrences of the first set of skills within the occupation and across occupations;
calculating a second set of scores for the second set of skills based on occurrences of the second set of skills within the course of study and across courses of study; and
combining the first and second sets of scores into the match score.

17. The system of claim 12, wherein the match score comprises a Jaccard distance.

18. The system of claim 12, wherein the one or more attributes comprise at least one of:
a standardized title;
a seniority; and
an industry.

19. The system of claim 12, wherein the one or more additional attributes comprise at least one of:
a degree;
a field of study;
a certification; and
a certificate.

20. A non-transitory computer-readable storage medium storing instructions that when executed by a computer cause the computer to perform a method, the method comprising:
aggregating a first set of skills associated with an occupation represented by one or more attributes;
aggregating a second set of skills associated with a course of study represented by one or more additional attributes;
calculating a match score representing a similarity between the first set of skills and the second set of skills; and
storing the match score in association with the occupation and the course of study.
